(19) United States
(12) Patent Application Publication
(10) Pub. No.: US 2026/0208607 A1
(43) Pub. Date: Jul. 23, 2026

(54) BATTERY SYSTEM COMPRISING MEANS FOR SYNCHRONIZING VOLTAGE AND REGULATING CURRENT WITH A POWER SUPPLY NETWORK

(71) Applicants: STELLANTIS AUTO SAS, Poissy (FR); CENTRALESUPELEC, GIF-SUR -YVETTE (FR); CENTRE NATIONAL DE LA RECHERCHE SCIENTIFIQUE, PARIS cedex 16 (FR); SAFT, LEVALLOIS PERRET (FR); SORBONNE UNIVERSITE, Paris (FR); UNIVERSITE PARIS-SACLAY, GIF-SUR-YVETTE (FR)

(72) Inventors: Francis ROY, Les Ulis (FR); Thomas PEUCHANT, Le Bouscat (FR); David HERPE, Tresses (FR); Eric LABOURE, Cachan (FR); Philippe FIANI, Antony (FR)

(21) Appl. No.: 19/142,559

(22) PCT Filed: Dec. 4, 2023
(86) PCT No.: PCT/FR2023/051903

§ 371 Date: Jun. 23, 2025

(30) Foreign Application Priority Data
Jan. 5, 2023 (FR) 2300095

(51) Int. Cl. B60L 53/22; B60L 53/62

(52) U.S. Cl. CPC B60L 53/22; B60L 53/62; B60L 2210/46; B60L 2240/547; B60L 2240/549

(57) ABSTRACT

The present invention relates to a battery system comprising a distributed multilevel inverter in elementary modules of cells of the battery, allowing the generation of an alternating voltage waveform on a current line of the battery and bidirectional operation on a power supply network. According to the invention, the battery control unit comprises a means (20) for determining electrical characteristics of an alternating voltage waveform of the supply network (RES), a means (21) for synchronizing the electrical characteristics of an alternating voltage waveform of the current line (LT1, LT2, LT3) of the battery system (BAT) with the power supply network waveform (RES), an electrical connection means (Kres) for connecting the current line (LT1, LT2, LT3) to the supply network (RES), controlled based on the synchronization state (STE) of the voltage waveforms of the battery system (BAT) and the network (RES), and a means for regulating the current (22) of the battery system (BAT) by controlling a voltage setpoint (Vref) of the current line of the battery system (BAT).

### CROSS-REFERENCE TO RELATED APPLICATIONS

This application is the US National Stage under 35 USC § 371 of International Application No. PCT/FR2023/051903, filed Dec. 4, 2023, which claims the priority of French application No. 2300095 filed on Jan. 5, 2023, the content (text, drawings and claims) of both said applications being incorporated by reference herein.

### BACKGROUND

This application relates to an electrochemical cell battery system comprising elementary cell modules forming a distributed multilevel inverter in the battery.

In fixed installations, electrochemical batteries are used in high-voltage power grids for grid regulation purposes, and to store energy generated by photovoltaic and wind power installations in particular. In the automotive sector, rechargeable electrified vehicles comprise a battery and power electronics equipped with voltage converters to adapt the current and voltage delivered by the battery to the vehicle's various on-board electronic components. For these vehicles, the power electronics generally comprise a charger for converting AC voltage to DC voltage for recharging the battery from an extended AC power power supply network.

Bidirectional chargers allow the battery to be charged from the power supply network, and discharged to an electrical system external to the vehicle, in so-called V2X (Vehicle to Everything) applications. For example, WO-A1-2022/200144 and WO-A1-2021004639A1 describe a vehicle power supply system comprising a bidirectional charger capable of charging the battery from the power supply network and supplying an external load connected to another outlet of the vehicle provided for this purpose.

These battery discharge solutions are designed solely to supply power to a load connected to a vehicle outlet, and do not discharge to a power supply network. In addition, these bidirectional chargers require AC/DC and DC/AC converter stages, which generally have energy losses of the order of 10 to 20% of the power delivered during conversion.

Efforts are being made to improve the energy efficiency of battery power supply systems. The applicant has developed a so-called distributed multilevel inverter breakthrough architecture that dispenses with the voltage converters usually integrated between an electrochemical cell battery and the AC power supply network. This architecture has been the subject of several patent applications by the applicant. Examples include WO-A1-2017/153366, WO-A1-2021/048477 and FR-A1-3121797. They describe a cell architecture comprising current lines formed by elementary modules, each comprising an electrochemical cell, or a cluster of cells, and a switching module forming an H-bridge. These documents further describe innovative control methods for this architecture, enabling cells to be balanced in terms of state of charge, and multiphase or direct current to be generated.

More specifically, it is possible to generate an AC voltage and current at the battery output that can be directly injected into an electric drive machine or the power supply network. This architecture is particularly efficient, since electrical efficiencies in charging and discharging have been measured at over 96%, and above all it eliminates the need for voltage conversion stages for electric vehicle applications. In stationary applications, such as renewable energy installations, where the battery system is used to store energy or regulate the network by controlled discharge, it is possible to connect the battery system directly to the power supply network without integrating a power conversion system (PCS). This means significant financial savings.

### SUMMARY

The aim is to propose an electrical energy storage system that alleviates the above-mentioned problems and improves the connection phase of such a system to the power grid. One aim is to offer a battery system for electric vehicle and stationary applications based on this integrated multilevel inverter structure, allowing bidirectional operation of the battery system with the AC, single-phase and polyphase power supply network. One aim is to provide a solution that optimizes the regulation of charging and discharging current on the power supply network.

More precisely, related herein is a battery system with electrochemical cells, intended to recharge/discharge on an extended power supply network operating with alternating voltage, the system comprising at least one current line comprising a plurality of elementary modules, each provided with a cell or a cluster of cells, forming a distributed multilevel inverter and a control unit for the elementary modules capable of generating a selected alternating voltage waveform at the terminals of the current line based on a voltage reference setpoint. The system further comprises:
means for determining electrical characteristics of an alternating voltage waveform from the power supply network,
means for synchronizing the electrical characteristics of an alternating voltage waveform of the current line of the battery system with the alternating voltage waveform of the power supply network,
an electrical connection means for connecting the current line to the power supply network, controlled based on a synchronization state of the voltage waveforms of the battery system and the network,
means for regulating the battery system current by controlling the voltage reference setpoint of the battery system current line.

The system may comprise the following additional features, alone or in combination:
it comprises three current lines, wherein the synchronization means comprises means for transforming the measured voltages of the battery system lines and the network into first vector controls, means for determining a first voltage setpoint in vector control by a first regulator taking the first vector controls as inputs, and first means for modulating the first voltage setpoint into a voltage reference setpoint for the battery system;
it comprises three current lines, wherein the current regulation means comprises means for transforming measured currents of the battery system lines and a reference current setpoint into second current vector controls, means for determining a second voltage setpoint in vector control by a second regulator taking the second vector controls as inputs, and second means for modulating the second voltage setpoint into a voltage reference setpoint for the battery system;
it further comprises an estimator of the phases of the power supply network, and wherein the means for transforming the first and/or second vector controls also depend on said phase estimates.
it further comprises an estimator of the voltage amplitude deviation between the voltage waveform of the power supply network and the battery system, and wherein the synchronization state is dependent on the deviation with respect to a predetermined error threshold.

Further related herein is an electrified motor vehicle comprising a rechargeable battery system and an electrical interface for connecting the battery system to an extended power supply network for recharging and discharging on the power supply network, wherein the battery system is according to any one of the preceding embodiments.

Further related herein is a stationary battery system comprising a rechargeable battery system and an electrical interface for connecting the battery system to an extended power supply network, wherein the battery system is according to any one of the preceding embodiments.

Further envisaged is a method of controlling an electrochemical cell battery system for discharging/recharging on an extended power supply network comprising the following successive steps:
determining electrical characteristics of an alternating voltage waveform from the power supply network,
synchronizing the electrical characteristics of an alternating voltage waveform of at least one current line of the battery system with the alternating voltage waveform of the power supply network,
electrically connecting the current line to the power supply network, if it is detected that the synchronization state of the voltage waveforms of the battery system and the network is below a predetermined error threshold,
then regulating the current of the line of the battery system by controlling a voltage reference setpoint adapted to the control of the battery system current line.

According to a variant, synchronization comprises the following steps:
transforming measured voltages of lines of the battery system and network into first vector controls,
determining a first voltage setpoint in vector control by a first regulator taking the first vector controls as inputs,
modulating the first voltage setpoint in vector control to generate the voltage reference setpoint adapted to controlling the battery system to generate the voltage waveform to be synchronized.

According to one variant, current regulation of the battery system comprises the following steps:
transforming measured currents of the battery system lines and a reference current setpoint into second current vector controls,
determining a second voltage setpoint in vector control by a second regulator taking the second vector controls as inputs,
modulating the second voltage setpoint in vector control to generate the voltage reference setpoint adapted to controlling the battery system to regulate the charge/discharge current of the battery system.

The control unit of the battery system comprises integrated circuit means specifically configured to implement the control method for recharging and discharging on the power supply network. A computer program comprises instructions which, when the program is executed by a control unit of the battery system, cause the latter to implement any of the embodiments of the control method for recharging and discharging on a power supply network.

The described devices offer the following advantages:

The method for synchronization and current regulation by the control unit improves charging and discharging safety by preventing overcurrent when the high-voltage contactors close.

Energy efficiency in recharging is significantly higher than known solutions in the state of the art, of the order of 98.5% observed experimentally. In electric vehicle applications, the cost of recharging and therefore of using a vehicle is greatly reduced.

Additionally, this recharging principle uses the same components whether recharging at 11 KW, 22 KW or even more in three-phase mode, and these same components are used to provide the vehicle's traction. In a conventional architecture, it is generally necessary to differentiate between conversion components for high-power recharging, in excess of 300 KW, and those for traction. This reduces the cost of power electronics.

### BRIEF DESCRIPTION OF THE FIGURES

Other features and advantages will become clearer on reading the following detailed description comprising embodiments given by way of non-limiting examples and shown by the appended drawings, wherein:

FIG. 1 schematically shows an embodiment of the electrical architecture of the battery system;

FIG. 2 shows the synchronization and current regulation functions of the battery system;

FIG. 3 are graphs showing the phase and voltage synchronization of the current lines of the battery system in accordance with the control method;

FIG. 4 are graphs showing the current regulation phase of the current lines of the battery system in accordance with the control method;

FIG. 5 shows a method of controlling the battery system, allowing the battery system to be recharged and discharged from a power supply network and the current to be regulated;

FIG. 6 schematically shows an embodiment of the battery system for an electrified vehicle.

### DETAILED DESCRIPTION

Related herein is an energy storage system for electrified motor vehicles and stationary storage systems in electrical installations, e.g. for renewable energy or network regulation installations. The system comprises an electrochemical battery comprising elementary cell modules interconnected to form a distributed multilevel inverter structure in the battery, allowing the battery to be connected to an electrical system operating with DC voltage and also with AC voltage without the intermediary of an inverter. The battery system can be connected directly to an extended power supply network and an electric drive machine. More specifically, disclosed are the means and method for synchronizing the battery system and for regulating the charging and discharging current on a power supply network.

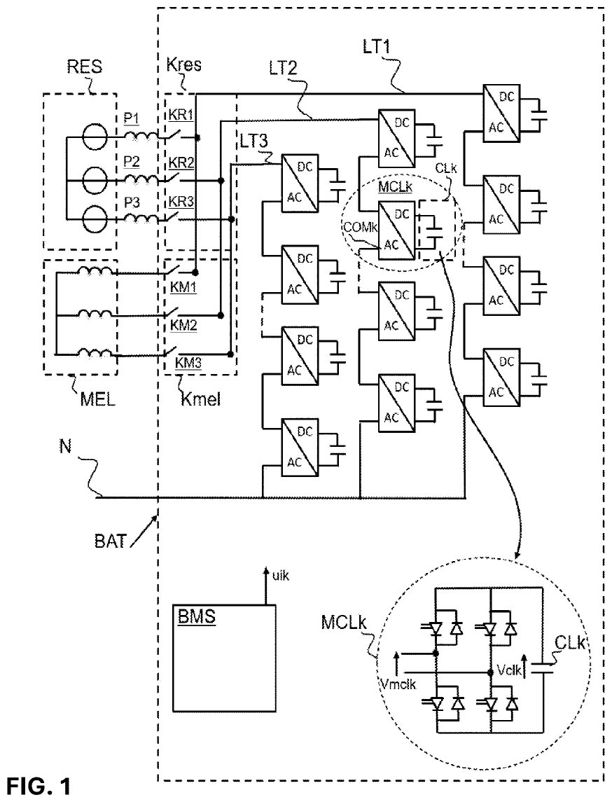

In the present description, the term “distributed multilevel inverter” is understood to mean that the current line or each current line of the battery, in the case of a polyphase, in particular three-phase, architecture, is formed by a plurality of elementary modules and each elementary module comprises a cell or a cluster of cells, as well as a switching module forming an H-bridge, the control unit comprises a means of controlling the elementary modules of the current line based on a reference setpoint and is able to generate a selected AC voltage waveform on each current line. This architecture is described in greater detail in FIG. 1.

Referring to FIG. 1, the battery system BAT comprises elementary modules MCLk forming the distributed multilevel inverter structure in the battery and comprises three current lines LT1, LT2 and LT3 wherein the elementary modules MCLk are arranged. Alternatively, the battery system BAT can comprise a single current line LT1, just two current lines, or four or more current lines. In short, the battery system can be single-phase or polyphase. The battery system BAT comprises high-voltage switches Kres, also known as high-voltage contactors, for electrically connecting the battery BAT to the power supply network RES. Each current line LT1, LT2 and LT3 is connected on one side to a network connection switch, KR1, KR2 and KR3, respectively, and on the other side to a neutral terminal N of the battery. The extended power supply network RES operates on 50 Hz or 60 Hz AC voltage, for example. The battery system BAT can produce three three-phase voltages offset by 2TT/3. The control of each current line is similar, differing only by an offset of 2TT/3 between them.

In the case of an electromobility application, the battery system BAT further comprises high-voltage switches Kmel for electrically connecting the battery BAT to the electric drive machine MEL. Each current line LT1, LT2 and LT3 is connected on one side to a connection switch of the electric machine, KM1, KM2 and KM3, respectively, and on the other side to a neutral terminal N of the battery. The electric drive machine can be an asynchronous or synchronous machine, or even a DC machine, as the battery system is capable of generating any voltage waveform, AC or DC.

In addition, switches (not shown in FIG. 1) can be provided to electrically connect the three lines LT1, LT2, LT3 in series, enabling the battery BAT to be connected to a single-phase network. Alternatively, the battery system BAT may comprise a single current line LT1.

The battery system BAT has a terminal voltage of several hundred volts, for example 350 volts or 1000 volts. At 350 volts, each line LT1, LT2, LT3 is equipped, for example, with 24 elementary cell modules or cell clusters connected in series. However, depending on electrical requirements, the battery system BAT may have a nominal voltage of only several tens of volts (e.g. 24 V, 36 V, 48 V), particularly for automotive applications, or a maximum voltage of 1500 Volts DC or even higher, particularly for stationary storage systems.

The battery system BAT further comprises a control unit BMS, one of whose functions is to control the voltage waveform of the line LT1 or each line LT1, LT2, LT3 based on a reference setpoint Vref from the elementary modules MCLk. Each elementary module MCLk may comprise a single cell CLK, or a cluster of cells CLK that may be two, three, four, five, six or more cells in number, forming the elementary voltage Volk. The elementary module MCLk further comprises a switching module COMk able to configure the elementary module MCLk in three different states to deliver the voltage Vmclk which is respectively said elementary voltage Volk, a zero voltage and the inverted voltage Volk to said connection terminals of the module MCLk.

The switching module COMk, for example, consists of two switching parts forming an H-bridge that can be controlled in three different states by a control signal from the control unit BMS of the battery BAT specifically addressing the module MCLk. The states are represented by a control variable uik which, for example, can take on the values 1, 0, −1 representing the three different states respectively controlling said elementary voltage Volk, a zero voltage and said inverted voltage-Volk at said connection terminals of the elementary module k addressed by the control signal uik. Each switching module COMk comprises electronic components, such as power transistors, possibly of the MOSFET or HEMT (High Electron Mobility Transistor) type, driven by control signals from the control unit BMS. In this way, the voltage Vmclk at the terminals of each elementary module MCLk among the totality n of modules can be controlled based on a control signal uik according to the following relationship:

$${u}_{ik} = \{ \begin{matrix}1 , & {v}_{mclk} = {V}_{clk} \\ 0 , & {v}_{mclk} = 0 \\ - 1 , & {v}_{mclk} = - {V}_{clk}\end{matrix} k = 1 … n \qquad [ Math 1 ]$$

On each voltage line LT1, LT2 and LT3, the control unit BMS can control any voltage waveform formed in amplitude steps equal to the elementary voltage Vclk based on a reference voltage setpoint Vref. The reference voltage setpoint Vref can be sinusoidal with a frequency of 50 Hz, any alternating form, e.g. square waveform, or can be a constant voltage, for example.

The control unit comprises means for synchronizing the reference voltage setpoint Vref with a network voltage and for regulating a charge and discharge current by regulating the reference setpoint Vref. The control unit BMS is able to determine, at each instant, the number q of elementary modules required from the plurality n to produce the voltage waveform for each voltage phase requested by the setpoint Vref and where all the elementary cells have the same elementary voltage Vclk.

An electrochemical cell is an electrical energy accumulator with two terminals, a positive and a negative electrode, and a voltage of a few volts, usually between 2.3 V and 4.2 V. Cells can be of the Lithium ion, Nickel Cadmium or Nickel-Metal-Hydride type. More specifically, a Lithium-ion cell consists mainly of a porous positive electrode, a porous negative electrode, a separator and an electrolyte. The operating principle of a Lithium-ion cell is based on the reversible exchange of lithium ions between the two porous electrodes. Cells can be of the Lithium iron phosphate, Lithium polymer or solid electrolyte type, for example.

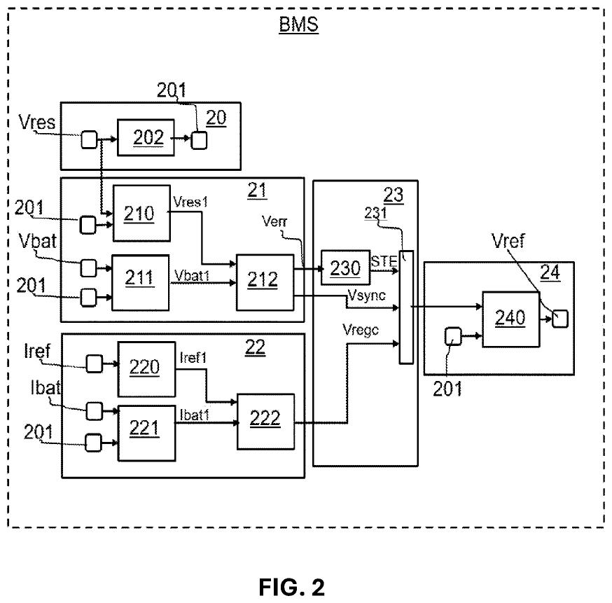

With reference to FIG. 2, the means of the control unit BMS have been described that implement the function of synchronizing the voltage waveforms generated by the battery system and regulating the charge and discharge current once the battery system is electrically connected to the power supply network. This embodiment is used to synchronize three-phase voltages. The synchronization function takes place before the battery system is electrically connected to the mains, that is to say before the switches KR1, KR2 and KR3 are closed, to avoid an overcurrent situation at the time of connection. This embodiment described in FIG. 2 is not limiting, and in particular, variants of the voltage synchronization and current regulation of the battery system can be single-phase or polyphase, that is to say two-phase, three-phase or more.

The control unit BMS is equipped with an integrated circuit computer and electronic memory, the computer and memory being configured for the functions involved in synchronization and current regulation. The control unit can be in the form of software modules, hardware or a combination of hardware and software modules, such as ASICs (Application Specific Integrated Circuits) or DSPs (Digital Signal Processors).

The control unit BMS comprises means for estimating or measuring the instantaneous electrical characteristics of a voltage waveform Vres of each current line of the power supply network. Measurement is possible when the battery system is not yet electrically connected to the network, that is to say when the switches KR1, KR2 and KR3 are open. Additionally, the control unit comprises means for estimating or measuring the instantaneous electrical characteristics of the voltage Vbat and current Ibat of each current line of the battery system. Referring to FIG. 2, these means are represented by the inputs Vres, Vbat and Ibat, respectively, of the control unit BMS. These means make it possible to estimate the value of the voltages Vres of the power supply network.

A means 20 is further provided for estimating the phase of each current line in the power supply network. It simultaneously estimates the frequency (around 50 Hz or 60 Hz) and phase shift 201 of the network voltages.

The control unit BMS comprises a voltage regulation module 21, the function of which is to synchronize the voltage and phase of the power supply network and the battery system, and a current regulation module 22, which controls the charging and discharging current once the battery system is synchronized with the network.

The function of the regulation module 21 is to regulate the battery system voltages in amplitude and phase, taking the power supply network voltages as a setpoint. From this regulator 21, the control unit determines a setpoint Vref which controls the control module of the battery cell cluster to generate voltage waveforms on each line during the synchronization phase.

The regulation module 21 can act either directly on the sinusoidal quantities, or via control of the direct and quadrature components which are estimated, or by control techniques involving mathematical transforms, for example. In single-phase or polyphase (two-phase, three-phase or more) operation, the regulation module 21 comprises a control loop implementing a compensator based on the estimated electrical characteristics of the battery system and the power supply network to control the voltage setpoint Vref of the line or each current line of the battery system.

In the case of a three-phase application, with reference to FIG. 2, means are provided for transforming 210 and 211 the voltage signals from the power supply network Vres and the battery system Vbat into a digital vector control model in the Park plane Vres1 and Vbat1, respectively, with a 50 Hz rotating field. The resulting vector controls Vres1 and Vbat1 are used in a control loop by a compensator 212 to determine a battery system voltage setpoint in the form of a vector control Vsync. Additionally, the compensator 212 determines an instantaneous error estimate Verr of the voltage signals.

The transformation means 210 and 211 are mathematical and signal processing functions performing a Park transform, known to the person of ordinary skill in the field of electrical engineering for controlling a three-phase electrical machine. The Park transform has the advantage of simplifying and improving the performance of current and voltage controllers. The possibility of implementing other control principles is not precluded. The compensator 212 is a known servo function that the person of ordinary skill will be able to adapt to control the voltage setpoint. The compensator 212 is, for example, proportional-integral. Other types of compensator are also possible. Alternatively, the transformation means 210 and 211 can be estimators of the sinusoidal electrical characteristics of the measured signals, or estimators of the direct and quadrature components.

A control switching module 23 selects either voltage regulation during the synchronization phase, or current regulation once synchronization has been achieved. The module 23 uses a control switching block 231 which activates one or the other control mode based on the estimated Verr error between the network and battery system voltages.

More specifically, a block 230 compares the error signal Verr with a predetermined threshold. As long as the signal Verr is above the threshold, voltage control remains operative. The resulting voltage setpoint Vsync from the regulation block 21 is used to control the battery and generate the waveform on each of the current lines.

When the signal Verr falls below the threshold, the block 230 detects that the voltage synchronization is correct in terms of amplitude and phase shift, and that the battery system can be electrically connected to the network. This activates the current regulation of the battery system. As the voltages are synchronized, an overcurrent effect in the battery system is avoided. The block 230 is able to control the high-voltage switches Kres referenced in FIG. 1. When synchronization is detected and held stable for a confirmation time, the switches are closed.

In addition, the control unit BMS comprises a modulation function 24 for delivering a voltage setpoint adapted to control of the battery system, based on a voltage setpoint from either the voltage regulation module 21 or the current regulation module 22. For voltage synchronization, the block 240 modulates the setpoint Vsync at the output of the voltage regulation feedback loop.

Identically to the transformation blocks 210 and 211, the block 240 takes as input the estimated phase shift 201 of the network voltage signals, so that the inverse transformation adapts to any network phase variability.

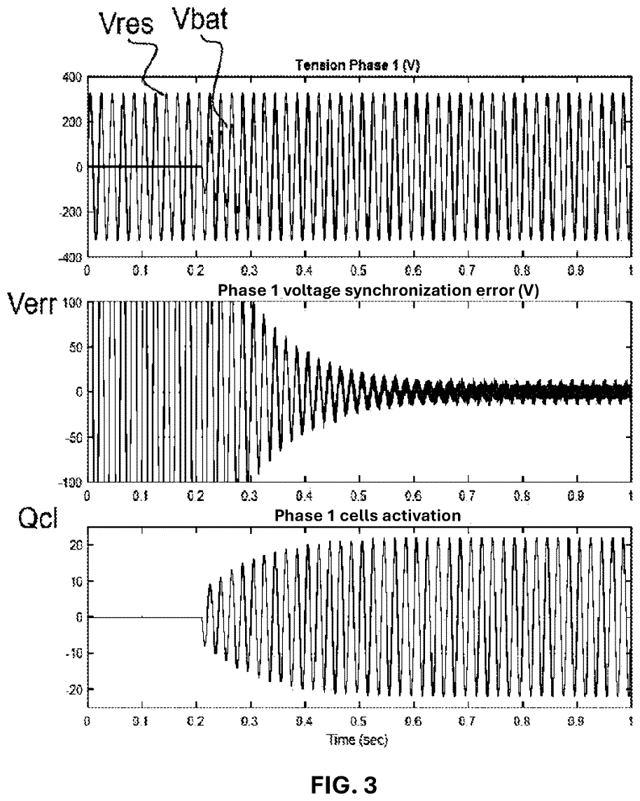

FIG. 3 is a graph showing a simulation of the voltage synchronization operation of the battery system. The abscissa is the time axis. In the upper frame, this graph shows the voltage of the battery system on a current line and the voltage of the power supply network, configured in this example as 400 Volts RMS, on the corresponding line. The middle frame shows the synchronization error Verr between the network and battery system voltages, expressed in Volts. The lower frame shows the number Qcl of cell clusters activated during synchronization. In this example, the current line comprises 24 cell clusters connected in series in the battery current line.

This graph shows that from 0.2 seconds onwards, the first battery cell clusters are activated, and the error decreases and then stabilizes at 0.6 seconds. The upper frame shows the gradual rise in battery voltage Vbat as a result of cell activation, where 22 of the 24 clusters are used. At the same time, the synchronization error decreases and, after a confirmation time, the control unit controls the closing of the current line contactor and current regulation is activated.

With reference to FIG. 2, the function of the regulation module 22 is to regulate the battery system in terms of current, taking as input parameters a reference current setpoint Iref and the instantaneous current Ibat estimated on the battery system in value Irms. From this regulator 22, the control unit determines a setpoint Vref which controls the control module of the battery cell cluster to generate voltage waveforms on each line during the synchronization phase.

The current is regulated by controlling the setpoint Vref of the battery system. Current regulation takes place via a feedback loop between the measured battery current and a current setpoint. The resulting current flowing through the battery system is dependent on a voltage amplitude deviation with respect to the network voltage. By regulating a voltage higher than that of the network, a discharge current is controlled, and by regulating a voltage lower than that of the network, a recharge current is controlled.

The current regulation module 22 can act either directly on the sinusoidal quantities, or via control of the direct and quadrature components which are estimated, or by control techniques involving mathematical transforms, for example. In single-phase or polyphase (two-phase, three-phase or more) operation, the regulation module 22 comprises a control loop implementing a compensator based on the measured electrical characteristics of the battery system and a current setpoint to control the voltage setpoint Vref of the line or each current line of the battery system.

In the case of a three-phase application, with reference to FIG. 2, transformation means 220 and 221 are provided for transforming a current setpoint Iref into amperes RMS and the measured current of the battery system Ibat into vector controls in the Park plane Iref1 and Ibat1, respectively, with a rotating field at 50 Hz. The resulting vector controls Iref1 and Ibat1 are used in a control loop by a compensator 222 to determine a battery system voltage setpoint in the form of a vector control Vregc.

The transformation means 220 and 221 are mathematical and signal processing functions performing a Park transform, known to the person of ordinary skill in the field of electrical engineering for controlling a three-phase electrical machine. The Park transform has the advantage of simplifying and improving the performance of current and voltage controllers. The possibility of implementing other control principles is not precluded. The compensator 222 is a known servo function that the person of ordinary skill will be able to adapt to control the voltage setpoint. The compensator 222 is, for example, proportional-integral. Other types of compensator are also possible. Alternatively, the transformation means 220 and 221 can be estimators of the electrical characteristics of the measured signals, or estimators of the direct and quadrature components.

Each of the functional transformation blocks 210 and 211 for voltage regulation and blocks 220 and 221 for current regulation takes as input the estimated phase shift 201 of the network voltage signals, so that the vector controls used in the control loop adapt to any variability in network phases. Indeed, the phases may vary in the event of a load demand or an increase in network energy production. This improves the precision of synchronization and current regulation.

The setpoint in vector control Vregc, generated by the current control 22, ensures current regulation by regulating the voltage setpoint Vref of the battery system for the or each current line. The setpoint Vregc is transmitted to the modulation block 240 once synchronization is detected to deliver a voltage reference setpoint suitable for controlling the battery system. The same modulation block 240 is used as for synchronization 21, or another modulation block specific to current regulation.

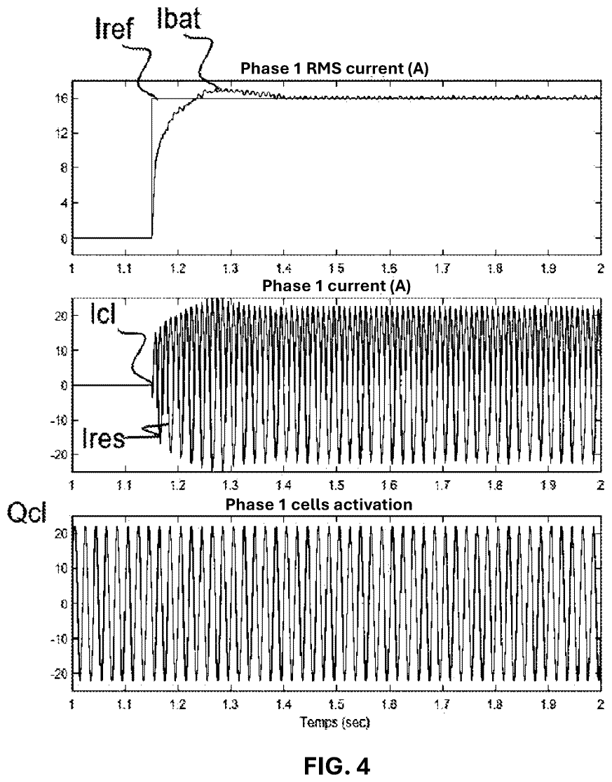

In FIG. 4, a graph shows a simulation of the current regulation operation of the battery system. The abscissa is the time axis. In the upper frame, this graph shows the current setpoint Iref and the resulting RMS value of a current line. The middle frame shows the line current of the network Ires and the corresponding line current of the battery system. The lower frame shows the number Qcl of cell clusters activated during current regulation. In this example, the current line comprises 24 cell clusters connected in series in the battery current line.

On this graph, from 1.15 seconds onwards, a current setpoint Iref is controlled at a value of 16 A RMS. Very quickly, the battery current value increases until it reaches the setpoint Iref at 1.4 seconds. The dynamics of current regulation during this transient phase are very rapid, since the impedance of the electrical circuit is very low. Current convergence takes place in less than 200 milliseconds. The shape of the current is stabilized, and the current through the clusters Icl is always positive. The alternating current Ires corresponds to the current in the network.

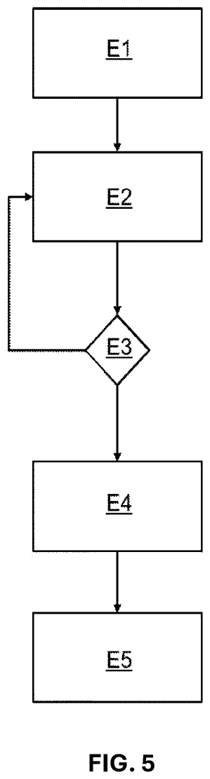

FIG. 5 shows a flow chart describing the control method of the battery system for synchronizing and regulating current charging and discharging. The method is implemented by the integrated circuit computing means of the battery system control unit. A computer program can be provided by the control unit of the battery system comprising instructions which, when the program is executed, cause it to implement the control method for synchronizing and regulating the current of the battery system. The method is applicable for charging and discharging on a single-phase and polyphase power supply network. Current synchronization and regulation can be carried out on one current line of the battery or on several current lines, for example two current lines of the battery in a two-phase configuration in connection with a two-phase network, three current lines of the battery in a three-phase configuration in connection with a three-phase network, or four or more current lines.

In a first step E1, the method comprises determining the electrical characteristics of a voltage waveform of the power supply network, in particular the voltage and phase of each current line of the network.

The method then comprises controlling the synchronization E2 of the electrical characteristics of the voltage waveform of the or each current line of the battery system with the waveform of the corresponding power supply network. During synchronization, the contactors Kres are open, as shown in FIG. 1. Synchronization consists in regulating the voltage value and phase of the battery system using the network voltage as a reference.

The method provides a step, during synchronization, for checking E3 a synchronization state to determine the closing time of the high-voltage contactors. The synchronization state is the voltage error between the network waveform and the battery voltage waveform with respect to a predetermined error threshold.

As long as the error is above the threshold, voltage regulation remains active and the resulting voltage setpoint drives the battery system. The contactors remain open.

As soon as the error falls below the error threshold, the method controls the electrical connection of the or each current line of the battery system to the power supply network in step E4.

Then, in step E5, the method controls the regulation of the current of the or each line of the battery system, taking into account a current setpoint I in RMS value and an estimate of the RMS current of the battery. The method involves determining a voltage setpoint for controlling the voltage waveform of the line of the battery system. By generating a voltage amplitude deviation between the synchronized voltage waveforms, either a charging current or a discharging current is generated on the or each current line of the battery.

The voltage and current control loops for synchronization E2 and current regulation E5 in the method consist of a control loop comprising a correction. In a non-limiting example, the control loop is of the PI correction type.

If the battery system and the network are three-phase, the voltage and current control loops for synchronization E2 and current regulation E5 comprise transformations or estimations of the setpoints and measured values of the battery system into vector control in the Park frame with a rotating field at 50 Hz. The Park transform has the advantage of simplifying and improving the performance of current and voltage controllers. The possibility of implementing other control principles is not precluded.

In addition, the control method can be applied to a single-phase or polyphase battery system. In single-phase or polyphase configuration, the voltage synchronization step E2 and current regulation step E5 can act either directly on the sinusoidal quantities, or via control of the direct and quadrature components which are estimated, or by control techniques involving mathematical transforms, for example.

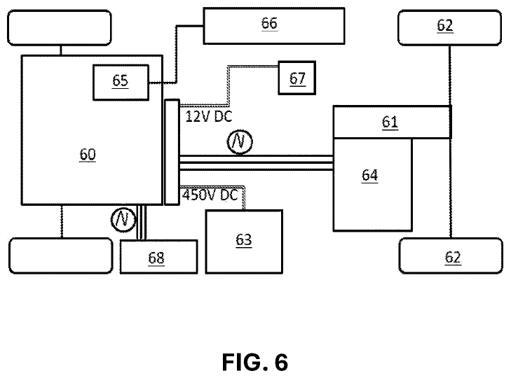

FIG. 6 shows the application of the battery system 60 for an electrified vehicle with all-electric or hybrid drive. The vehicle comprises an electric drive machine 64 capable of transmitting torque to the vehicle's drive wheels 62 via a transmission 61. The electric machine 64 may be a three-phase machine. The vehicle comprises a battery system 60 according to the distributed multilevel inverter architecture in the battery as described in FIG. 1. The battery comprises three current lines that can generate three-phase voltage waveforms. The vehicle further comprises an interface for recharging the battery 68 from a power supply network operating on AC voltage. The recharging interface 68 is a recharging box electrically connecting the terminals of the battery 60 to the terminal for AC voltage recharging in accordance with the method. The recharging interface 68 is also suitable for fast DC voltage recharging. The battery system 60 is advantageous in that its control unit 65 adapts the voltage waveform in AC or DC waveform without the need for a voltage converter.

The vehicle further comprises a supervisory system 66 cooperating with the control unit 65 of the battery system 60. The battery system 60 can be directly electrically connected to the electric drive machine 64, thus improving its traction energy efficiency. The battery can further be connected to an on-board high-voltage DC power supply network 63 of the vehicle, for example operating at a nominal voltage of 350 volts, and to a low-voltage on-board power supply network 67 operating at a nominal voltage of 12 volts, including a battery. The on-board DC voltage networks 63 and 67 can be supplied by the battery 60 via an AC/DC converter, if required.

Similarly, the battery 60 can be electrically connected securely to an external extended power supply network, via a recharging terminal operating on AC voltage after the synchronization phase has been implemented. And the regulation of the charging and discharging current is controlled by the control unit 65 of the battery by regulating the voltage of the lines of the battery system 60.

1. A battery system with electrochemical cells, intended to recharge/discharge on an extended power supply network operating with alternating voltage, the system comprising at least one current line comprising a plurality of elementary modules, each provided with a cell or a cluster of cells, forming a distributed multilevel inverter and a control unit for the elementary modules capable of generating a selected alternating voltage waveform at the terminals of the current line based on a voltage reference setpoint, wherein the system further comprises:
means for determining electrical characteristics of an alternating voltage waveform from the power supply network,
means for synchronizing the electrical characteristics of an alternating voltage waveform of the current line of the battery system with the alternating voltage waveform of the power supply network,
an electrical connection means for connecting the current line to the power supply network, controlled based on a synchronization state of the voltage waveforms of the battery system and the network,
means for regulating the battery system current by controlling the voltage reference setpoint of the battery system current line.

2. The system according to claim 1, comprising three current lines, wherein the synchronization means comprises means for transforming the measured voltages of the battery system lines and the network into first vector controls, means for determining a first voltage setpoint in vector control by a first regulator taking the first vector controls as inputs, and first means for modulating the first voltage setpoint into a voltage reference setpoint for the battery system.

3. The system according to claim 1, comprising three current lines, wherein the current regulation means comprises means for transforming measured currents of the battery system lines and a reference current setpoint into second current vector controls, means for determining a second voltage setpoint in vector control by a second regulator taking the second vector controls as inputs, and second means for modulating the second voltage setpoint into a voltage reference setpoint for the battery system.

4. The system according to claim 2, further comprising an estimator of the phases of the power supply network, and wherein the means for transforming the first and/or second vector controls also depend on said phase estimates.

5. The system according to claim 1, further comprising an estimator of the voltage amplitude deviation between the voltage waveform of the power supply network and the battery system, and wherein the synchronization state is dependent on the deviation with respect to a predetermined error threshold.

6. An electrified motor vehicle comprising a rechargeable battery system and an electrical interface for connecting the battery system to an extended power supply network for recharging and discharging on the power supply network, wherein the battery system is according to claim 1.

7. A stationary battery system comprising a rechargeable battery system and an electrical interface for connecting the battery system to an extended power supply network, wherein the battery system is according to claim 1.

8. A method of controlling an electrochemical cell battery system for discharging/recharging on an extended power supply network comprising the following successive steps:
Determining electrical characteristics of an alternating voltage waveform from the power supply network,
Synchronizing the electrical characteristics of an alternating voltage waveform of at least one current line of the battery system with the alternating voltage waveform of the power supply network,
Electrically connecting the current line to the power supply network, if it is detected that the synchronization state of the voltage waveforms of the battery system and the network is below a predetermined error threshold,
Then regulating the current of the line of the battery system by controlling a voltage reference setpoint adapted to the control of the battery system current line.

9. The control method according to claim 8, wherein the synchronization comprises the following steps:
transforming measured voltages of lines of the battery system and network into first vector controls,
determining a first voltage setpoint in vector control by a first regulator taking the first vector controls as inputs,
modulating the first voltage setpoint in vector control to generate the voltage reference setpoint to generate the voltage waveform to be synchronized.

10. The control method according to claim 8, wherein the current regulation of the battery system comprises the following steps:
transforming measured currents of the battery system lines and a reference current setpoint into second current vector controls,
determining a second voltage setpoint in vector control by a second regulator taking the second vector controls as inputs, modulating the second voltage setpoint in vector control to
generate the voltage reference setpoint to regulate the charge/discharge current of the battery system.
